(19) United States
(12) Patent Application Publication
(10) Pub. No.: US 2012/0306805 A1
(43) Pub. Date: Dec. 6, 2012

(54) HAND-WORN DEVICE WITH FINGER ACTIVATION AND CONTROL MECHANISMS

(75) Inventor: Raymond CHAN, Hong Kong (HK)

(73) Assignee: IDT TECHNOLOGY LIMITED, Hong Kong SAR (CN)

(21) Appl. No.: 13/372,463

(22) Filed: Feb. 13, 2012

Related U.S. Application Data
(60) Provisional application No. 61/491,335, filed on May 31, 2011.

(51) Int. Cl. G06F 3/044

(52) U.S. Cl. 345/174

(57) ABSTRACT

The present invention discloses a sensing device comprising a capacitive sensor for detecting capacitance variation and converting the capacitance variation into a first electrical signal; a piezoelectric sensor for detecting physical shock and converting the physical shock into a second electrical signal; and a display unit; wherein the information displayed on the display unit is controlled by the first electrical signal and the second electrical signal. The thickness and area of the capacitive sensor are designed to be optimal such that the sensing device has a highly reliable sensibility. In addition to the capacitive sensor, the sensing device of the present invention further includes a piezoelectric sensor for detecting physical shock, providing an alternate sensing technique for the users to choose.

### CROSS-REFERENCE TO RELATED APPLICATION

This application claims benefit under 35 U.S.C. §119(e) of U.S. Provisional Application having Ser. No. 61/491,335 filed on May 31, 2011, which is hereby incorporated by reference herein in its entirety.

### FIELD OF INVENTION

This invention relates to a sensing device, and in particular a touch/tap activation device with capacitive/vibration sensibility.

### BACKGROUND OF INVENTION

Nowadays, touch-sensitive devices become more and more common and are replacing the conventional devices which use push-button switches for selecting and controlling the functions of the devices. Capacitive sensors are usually used in touch-sensitive devices. However, when the size of the device continues to reduce, the surface area of the capacitive sensors are not reducing at the same rate, meaning that the number of sensors is reduced. A device with more ways of allowing user operation is desired.

Further, the touch-sensitive devices in the market have a common problem, false activation. For example, when a user's hand or other body parts unintentionally come close to the touching area or when water falls on the touching area, it may lead to false activation which causes inconvenience to the users.

### SUMMARY OF INVENTION

In the light of the foregoing background, it is an object of the present invention to provide an alternate sensing device with high touching accuracy.

In one aspect, the present invention is a sensing device comprising a capacitive sensor for detecting capacitance variation and converting the capacitance variation into a first electrical signal; a piezoelectric sensor for detecting physical shock and converting the physical shock into a second electrical signal; and a display unit; wherein the information displayed on the display unit is controlled by the first electrical signal and the second electrical signal.

In an exemplary embodiment of the present invention, the information displayed on the display unit comprises time, figure, text and symbol. The sensing device further comprises an audio output unit for outputting an audio signal, and the audio output unit is controlled by the first electrical signal and the second electrical signal

In another exemplary embodiment, the sensing device of the present invention further comprises a first processing circuit for processing signal sensed by the capacitive sensor and a second processing circuit for processing signal sensed by the piezoelectric sensor.

In another implementation, the sensing device of the present invention further comprises a heart rate monitor for monitoring heart rate based on a third electrical signal. In addition, the sensing device further comprises an attachment band which allows the sensing device to be worn on a user's wrist.

In yet another embodiment, the first processing circuit comprises a calibration capacitor having a capacitance between 0-10 pF. The capacitive sensor comprises a crystal with 2.0 mm thickness, and the capacitive sensor further has an area of around 18 mm², such that the capacitive variation is between 4-30 pF.

In on embodiment, the sensing device further comprises a capacitive adjustment unit for adjusting the capacitance of the calibration capacitor so as to allow a user to adjust the sensitivity of the capacitive sensor.

In another embodiment, the sensing device further comprises a disabling function for disabling the at least one capacitive sensor and the piezoelectric sensor based on a user's need.

In another aspect, the present invention is a method for sensing manipulation of a sensing device by a user, which comprises the steps of: detecting capacitance variation due to an action of the user and converting the capacitance variation into a first electrical signal; detecting physical shock due to the action of the user and converting the physical shock into a second electrical signal; and displaying information based on the first electrical signal and the second electrical signal.

In an embodiment, the method further comprises outputting an audio signal based on the first electrical signal and the second electrical signal.

In yet another embodiment, the method further comprises monitoring heart rate of the user based on a third electrical signal.

In a further embodiment, the method comprises using a calibration capacitor with capacitance of 0-10 pF to reduce false activation.

In another embodiment, the method comprises adjusting the capacitance of the calibration capacitor so as to allow the user to adjust the sensitivity.

There are many advantages to the present invention. In addition to the capacitive sensor, the sensing device of the present invention further includes a piezoelectric sensor for detecting physical shock, providing an alternate sensing technique for the users to choose. The piezoelectric sensor does not need to have any surface area dedicated thereto, therefore the surface area can be minimized while providing an alternate sensing mechanism. The thickness and area of the crystal of the capacitive sensor with the calibration capacitor are designed to be optimal such that the sensing device has a highly reliable sensibility.

Another advantage of the present invention is that the sensing device comprises a sense disabling function so as to prevent false activation.

### BRIEF DESCRIPTION OF FIGURES

FIG. 1 is a top view of the sensing device according to one embodiment of the present invention.

FIG. 2 is a cross section diagram of the sensing device according to one embodiment of the present invention.

FIG. 3 is a touch sensitive circuit diagram of the sensing device according to one embodiment of the present invention.

FIG. 4 shows a wave diagram illustrating the output of a touch detecting circuit according to one embodiment of the present invention.

FIG. 5 shows a shock sensitive circuit diagram of the sensing device according to one embodiment of the present invention.

### DETAILED DESCRIPTION OF THE PREFERRED EMBODIMENTS

As used herein and in the claims, “comprising” means including the following elements but not excluding others.

As used herein and in the claims, “couple” or “connect” refers to electrical coupling or connection either directly or indirectly via one or more electrical means unless otherwise stated.

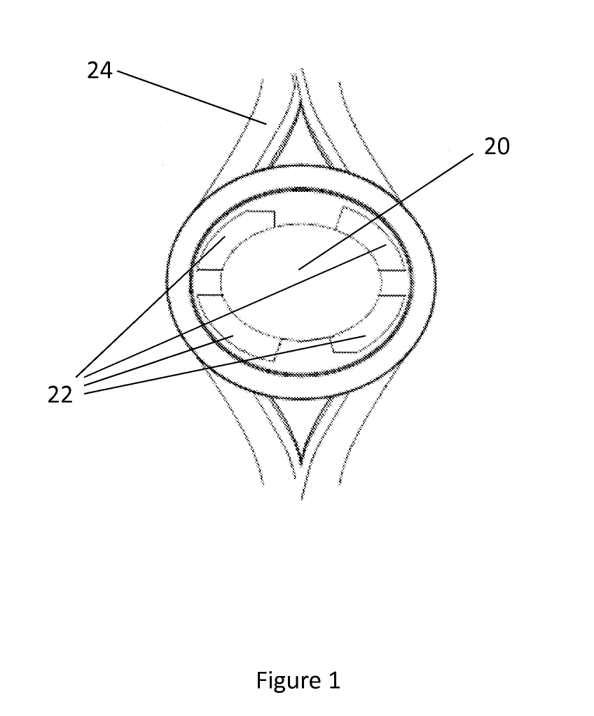

Referring now to FIG. 1, the top view of the sensing device in the first embodiment of the present invention is shown. In the center of the sensing device, there is a display unit 20 for displaying information to the users. In one embodiment, the display unit 20 is a LCD display and it is capable of displaying time, figure, text and symbol. Around the display unit 20, there is a plurality of sensitive pads 22 on top of capacitive sensors which can detect capacitive variations. In an exemplary embodiment, the capacitance varies in a predefined range of 4-30 pF. In an exemplary embodiment, the sensitive pads 22 of the capacitive sensors are optically transparent. In addition, the sensing device has an attachment strap 24 so that the sensing device can be worn on a user's wrist.

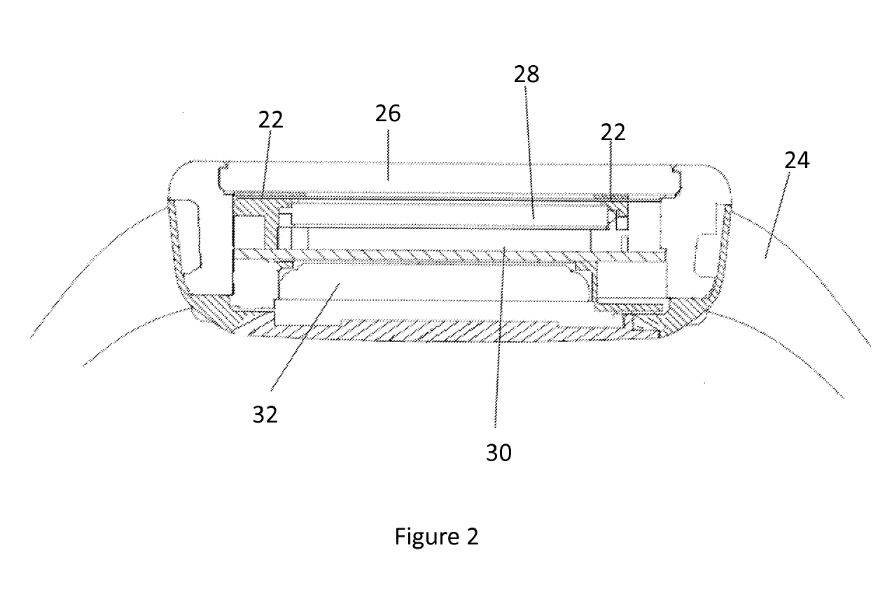

Referring now to FIG. 2, the cross section diagram of the sensing device according to one embodiment of the present invention is shown. On the top of the sensitive pad 22, there is a crystal cover 26 which is made of a dielectric material, for example mineral glass, organic glass or sapphire. The display unit 20 has a liquid crystal display 28 that can display information in the forms of digit, figure, text and symbol. In one embodiment, the sensing device includes a battery 32 which supplies power to the electronic circuit 30 for driving the whole sensing device.

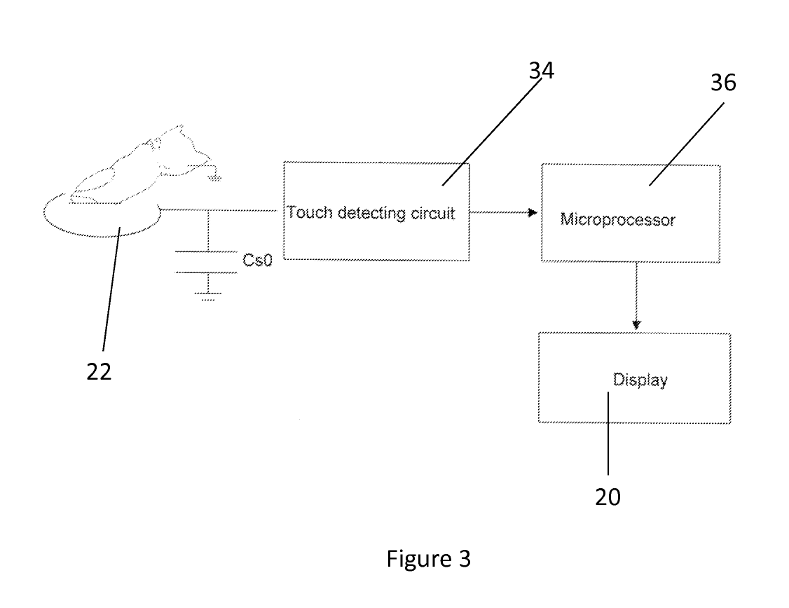

Now turning to the operation of the device described above, FIG. 3 shows a touch sensitive circuit diagram of the sensing device according to one embodiment of the present invention. When the sensitive pad 22 is touched by the user's finger, the capacitance variation will be detected by the touch detecting circuit 34 which will convert the capacitance variation into a first electrical signal and then output to the microprocessor 36. The microprocessor 36 will recognize the signal and performs a specific function based on the signal, such as changing the time to be displayed. Afterwards, control signal and relevant data will be sent to the display unit 20 for displaying suitable information to the users. In a preferred embodiment, there is a calibration capacitor Cs0 between the capacitive sensor and the touch detecting circuit 34. The calibration capacitor Cs0 has a capacitance range of 0-10 pF while the capacitive variations is within the predefined range of 4-30 pF. By adjusting the capacitance of Cs0, the sensitivity of the sensing device can be tuned. If Cs0 is absent, the sensing device may be too sensitive that false activation will occur frequently. However, if the capacitance of Cs0 is too high, the sensing device may become unresponsive even though the users touch the sensing pad 22. Therefore, the capacitance of Cs0 is optimized so that the sensing device have suitable sensitivity but may not lead to false activation when there is an unintentional touch or water drop.

In one embodiment of the present invention, to further reduce the rate of false activation, the sensing device comprises a capacitive adjustment unit for adjusting the capacitance of the calibration capacitor Cs0 so as to allow the users to adjust the sensitivity of the capacitive sensor according to their personal needs.

As in FIG. 3, the capacitive sensor is switched on by the finger to reference the plate potential to the ground. The touch detecting circuit 34 detects the capacitance variation based on the equation:

$$C = {ɛ}_{r} {ɛ}_{0} \frac{A}{d}$$

Where C is the capacitance; A is the area of overlap of the two plates; ∈ᵣ is the relative static permittivity (sometimes called the dielectric constant) of the material between the plates (for a vacuum, ∈ᵣ=1); ∈₀ is the electric constant (∈₀≈8.854×10⁻¹² F m⁻¹); and d is the separation between the plates.

Referring to FIG. 2 again, in one embodiment, the thickness of the crystal cover 26 is selected to be 2.0 mm. The thickness of the crystal cover 26 may also affect the sensitivity of the capacitive sensors. Based on a same medium such as glass having a dielectric constant ranging from 7.6 to 8.0, the sensitivity will be increased if a thinner crystal cover 26 is used. The thickness of the crystal cover 26, in the present invention, is chosen to be 2.0 mm because this thickness meets the requirement of sensitivity and can reduce the rate of false activation as well. Moreover, the surface area of the sensitive pad 22 also affect the sensitivity of the capacitive sensor and thus it is carefully designed to be 18 mm² which is optimal to increase the sensing accuracy. By using the optimal thickness of the crystal cover 26 and the optimal surface area of the sensitive pad 22, the capacitance variation detected is between 4-30 pF which can provide a reliable sensitivity but low false activation rate.

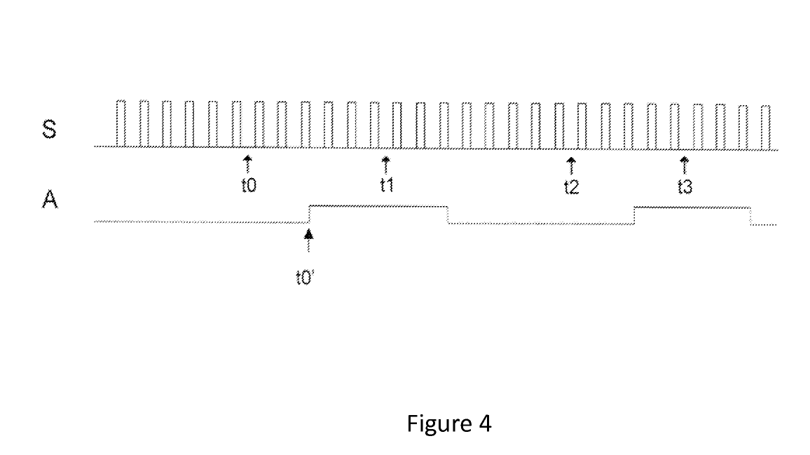

Turning to FIG. 4, a wave diagram illustrating the output of the touch detecting circuit 34 according to one embodiment of the present invention is shown. A source S applies voltage pulses to the capacitive sensor at regular intervals. Different capacitance between the sensitive pads 22 will result in different behavior of the processing circuit. For example, a larger capacitance will result in a slower response time of the processing circuit. When the user touch the sensing pad at time t0 and release at time t1, the processing circuit touch detecting circuit 34 will output signal A at time t0′. Signal A will be transmitted to the microprocessor 36 and thus a touch activation is recognized.

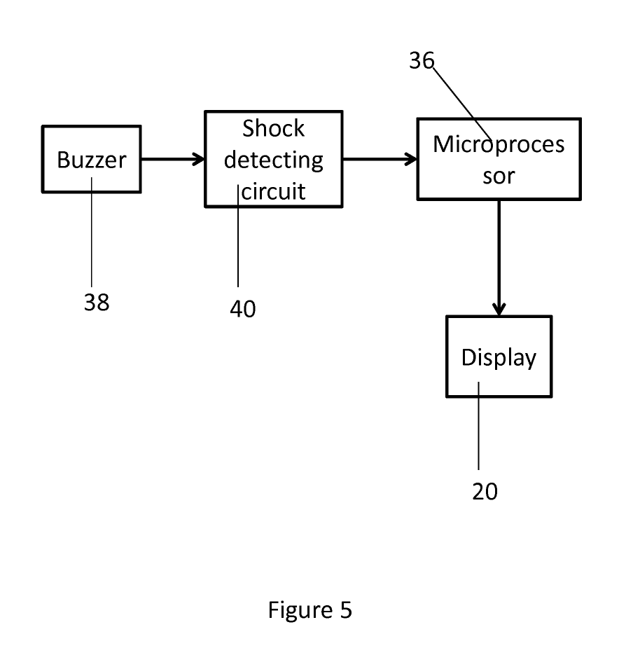

In another embodiment, the sensing device further comprises a piezoelectric sensor for detecting physical shock. The piezoelectric sensor can be triggered by tapping on the sensing device or shaking the sensing device. Referring to FIG. 5, a shock sensitive circuit diagram of the sensing device according to one embodiment of the present invention is shown. The piezoelectric sensor uses a buzzer 38 as the shock detector in a preferred embodiment. When the user taps on the sensing device or shakes the sensing device, the shock is detected by the shock detecting circuit 40. Then the shock detecting circuit 40 will convert the physical shock detected into a second electrical signal and forward it to the microprocessor 36 for processing. Based on the second electrical signal, the microprocessor will send suitable data to the display unit 20 for displaying information to the users. The piezoelectric sensor may also have false activation when a pressure is exerted accidently on the surface of the sensors.

In a further embodiment of the present invention, a disabling function is added to the sensing device so as to totally avoid false activations of capacitive sensors and piezoelectric sensor. When the disabling function is turned on, the capacitive sensors and piezoelectric sensor will be disabled. In one embodiment, the disabling function is triggered by contiguous double tapping on the sensing device, to turn on the sensors, contiguously double tapping on the sensing device again.

In one embodiment, the microprocessor 36 sets priority between signals generated from the two types of sensors. For example, when a user taps on the sensitive pad 22, it is possible that both sensors are activated, based on the physical shock of tapping, and the change of capacitance from the user touching the sensitive pad 22. In one embodiment, only the second electrical signal generated from the piezoelectric sensor is sent to the microprocessor 36, while the first electrical signal is ignored by the microprocessor 36 or not even generated at the capacitive sensor.

In another embodiment, the microprocessor 36 allows both electrical signals to be processed simultaneously. This allows additional forms of user manipulation such as tapping on or shaking the device while touching at least one capacitive pad.

In yet another embodiment, the sensing device comprises an audio output unit for outputting an audio signal. The audio output unit is controlled by the first electrical signal and the second electrical signal as mentioned above. The audio output unit can be used as an alarm and it can also generate responsive sounds to the manipulation of the users.

In another embodiment, the sensing device further comprises a heart rate monitor. The heart rate monitor can use the original piezoelectric sensor as the heart rate detector. When the sensing device is worn on the user's wrist, the heart rate monitor can detect the user's heart rate by adjusting the sensitivity of the original piezoelectric sensor. In yet another embodiment, the sensing device further comprises a second piezoelectric sensor with high sensitivity as the heart rate monitor. Under the heart rate mode, the heart rate monitor will generate a third electrical signal to the microprocessor 36 for processing and then displaying the result on the display unit 20.

In one embodiment of the present invention, the sensing device is a watch with reliable touch recognition and heart rate monitoring function. Such a watch is suitable for the elderly or people with heart attack because they can monitor their heart rate anytime. The watch is also with less false activation rate over conventional watches.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the shape of sensing device is described as circle in FIG. 1 above, but it is clear that other shapes and sizes may be used according to the user's preference, such as oval, square, or rectangular in shape. The crystal cover 26 can use other dielectric materials such as mica, plastics or oxides of various metals.

What is claimed is:

1. A sensing device comprising:
a) at least one capacitive sensor for detecting capacitance variation and converting said capacitance variation into a first electrical signal;
b) a piezoelectric sensor for detecting physical shock and converting said physical shock into a second electrical signal; and
c) a display unit;
wherein information displayed on said display unit is controlled by said first electrical signal and said second electrical signal.

2. The device of claim 1, wherein said information displayed on said display unit comprises time, figure, text and symbol.

3. The device of claim 1 further comprises an audio output unit for outputting an audio signal, and said audio output unit is controlled by said first electrical signal and said second electrical signal.

4. The device of claim 1 further comprises a first processing circuit for processing signal sensed by said capacitive sensor and a second processing circuit for processing signal sensed by said piezoelectric sensor.

5. The device of claim 1 further comprises a heart rate monitor for monitoring heart rate based on a third electrical signal.

6. The device of claim 1 further comprises an attachment band which allows said sensing device to be worn on a user's wrist.

7. The device of claim 4, wherein said first processing circuit comprises a calibration capacitor having a capacitance between 0-10 pF for reducing false activation.

8. The device of claim 1, wherein said at least one capacitive sensor comprises a crystal with 2.0 mm thickness, and said at least one capacitive sensor further has an area of 18 mm², such that the capacitive variation is between 4-30 pF.

9. The device of claim 7 further comprises a capacitive adjustment unit for adjusting said capacitance of said calibration capacitor so as to allow a user to adjust the sensitivity of said capacitive sensor.

10. The device of claim 1 further comprises a disabling function for disabling said at least one capacitive sensor and said piezoelectric sensor based on a user's need.

11. A method for sensing manipulation of a sensing device by a user, comprising:
a.) detecting capacitance variation due to an action of said user and converting said capacitance variation into a first electrical signal;
b.) detecting physical shock due to said action of said user and converting said physical shock into a second electrical signal; and
c.) displaying information based on said first electrical signal and said second electrical signal.

12. The method of claim 11 further comprises outputting an audio signal based on said first electrical signal and said second electrical signal.

13. The method of claim 11 further comprises monitoring heart rate of said user based on a third electrical signal.

14. The method of claim 11 further comprises using a calibration capacitor with capacitance of 0-10 pF to reduce false activation.

15. The method of claim 14 further comprises adjusting said capacitance of said calibration capacitor so as to allow said user to adjust the sensitivity.
